(19) United States
(12) Patent Application Publication
(10) Pub. No.: US 2025/0116515 A1
(43) Pub. Date: Apr. 10, 2025

(54) SEMI-CIRCULAR LEVEL

(71) Applicant: PATRICK SMITH, EUSTIS, FL (US)

(72) Inventor: PATRICK SMITH, EUSTIS, FL (US)

(21) Appl. No.: 18/883,382

(22) Filed: Sep. 12, 2024

Related U.S. Application Data
(63) Continuation of application No. 29/865,068, filed on Jul. 6, 2022, now abandoned.

(51) Int. Cl. G01C 9/28; G01C 9/36

(52) U.S. Cl. CPC G01C 9/28; G01C 9/36

(57) ABSTRACT

A semi-circular tool incorporating a bull's eye (surface) spirit level to be used by workers in the construction and building industries who desire a more efficient and accurate means to create level seat cuts on pilings which form the substructure of buildings constructed near or in water. Said tool may be used in conjunction with a laser, or transit, level to make the seat cuts level on several pilings simply and efficiently. Lastly, said design is fabricated from lightweight, cast aluminum metal to assist in its ease-of-use, durability, and affordability, and comes in three standard sizes: eight-, 10-, and 12-inch diameters.

### CROSS-REFERENCES TO RELATED APPLICATIONS

This Application claims priority to U.S. application Ser. No. 29/865,068, filed Jul. 6, 2022, pending.

### FIELD OF THE INVENTION

The claimed Circular Carpenter's Surface Level tool is used to ensure the seat mark on a piling is level, used in place of a straight torpedo level.

### BACKGROUND

Heretofore, several spirit levels have been designed for use in the building and construction industry, including:
SPIRIT LEVEL; application Ser. No. 04/762,884; Filed: Sep. 26, 1968.
CARPENTER'S LEVEL (STRAIGHT LEVEL); application Ser. No. 15/731,465; Filed: Jun. 13, 2017, Prior Publication Data, US 20180356219 A1 Dec. 13, 2018
TORPEDO LEVEL, Spirit Level, U.S. Pat. No. 1,061,638 Issued May 13, 1913
MACHINIST'S PRECISION LEVEL (BULL'S EYE, SURFACE OR BUBBLE LEVEL), U.S. Pat. No. 2,316,777,Filed: Aug. 1, 1940
LASER LEVEL (TRANSIT LEVEL), U.S. Patent D929,2493, Appl. No. D/740,789, Filed: Jul. 7, 2020.

A spirit level for marking a substantially circular object is provided which solves certain problems in the art when using a straight edged level.

### DESCRIPTION OF THE DRAWINGS

FIG. 1 is a top plan view of one embodiment of the Circular Carpenter's Surface Level tool according to this invention.

FIG. 2 is a shaded cross-section view of the Circular Carpenter's Surface Level tool according to this invention.

FIG. 3 is an isometric view of the Circular Carpenter's Surface Level tool according to this invention.

FIG. 4 is a shaded isometric view of the Circular Carpenter's Surface Level tool according to this invention,

### SUMMARY OF INVENTION

A semi-circular tool incorporating a bull's eye (surface) spirit level to be used by workers in the construction and building industries who desire a more efficient and accurate means to create level seat cuts on pilings which form the substructure of buildings constructed near or in water. Said tool may be used in conjunction with a laser, or transit, level to make the seat cuts level on several pilings simply and efficiently. Lastly, said design is fabricated from lightweight, cast aluminum metal to assist in its ease-of-use, durability, and affordability, and comes in three standard sizes: eight-, 10-, and 12-inch diameters.

### DETAILED DISCLOSURE OF THE PREFERRED EMBODIMENTS OF THE INVENTION

The Circular Carpenter's Surface Level tool according to this invention is based upon earlier spirit or bubble level-type tools, such as the standard carpenter's level tool, standard torpedo level tool, and the bull's eye, or surface, level tool, used in the building and construction industry to provide guidance to industry workers in the field when they are required to establish the true level, or horizontal position, of an object during the building process.

Previously, the mentioned carpenter or torpedo level tools were used to make the mark for each seat cut on a piling. Pilings are large, round posts set into the ground that carry the weight of structures, such as buildings on stilts, piers, docks, and boardwalks.

It is imperative that each piling is cut precisely level with every other piling used to support the floor of the building which will rest upon them. Typically, buildings that are constructed near or in water must be set upon pilings to avoid flooding of the building during high-water events. The mentioned seat cut is the notch made in a piling where a girder is intended to be placed. Girders are long beams carried by pilings upon which the structure above actually rests. Construction projects, such as boardwalks, could have hundreds-if not thousands-of pilings which must all have a seat cut applied to each piling. This process is currently laborious, time-consuming, and inefficient since the above-mentioned level tools must be manually moved around the circumference of each piling inch-by-inch until a complete seat cut mark has been made.

The Circular Carpenter's Surface Level of this invention is used in place of the mentioned standard carpenter or torpedo level tool when an industry worker needs to accurately establish the level mark indicating where a seat cut for a girder must be made on a piling. Using this device, the seat cut mark can be made in one motion once the tool has been placed upon the piling, saving time and effort, and allowing for a more accurate seat cut mark.

Used in conjunction with the Circular Carpenter's Surface Level tool, the laser level, or transit, tool establishes the point on each piling where the device must be placed to create the seat cut mark. The mentioned laser level tool is used to ensure that each seat cut is placed at the same height on each piling, while the device of this invention is used in place of the mentioned standard carpenter or torpedo level tools for making the seat cut mark level around the circumference of each piling. It is important that each seat cut across all pilings are level so that the floor of the structures above will be level, as well.

The Circular Carpenter's Surface Level tool differs from the mentioned alternative level tools known in the art in that it offers the industry worker a bull's eye (surface) spirit level set within a semi-circular frame. Said design will easily fit around the circumference of a piling to immediately make an accurate semi-circular mark on the piling where aforementioned level tools cannot, since the mentioned level tools are straight as opposed to semi-circular.

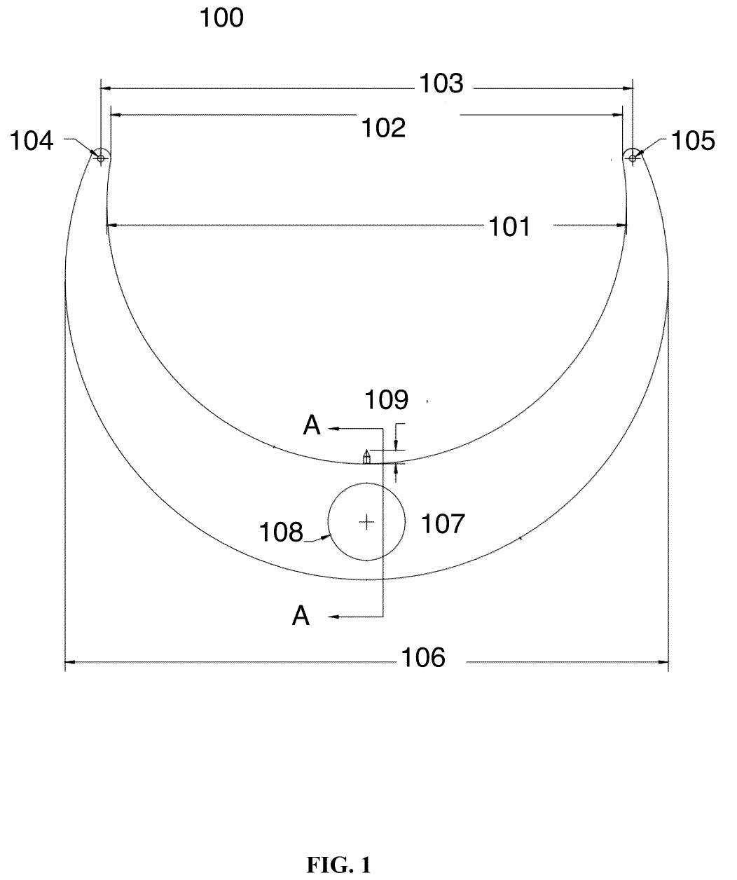

The Circular Carpenter's Surface Level tool according to this invention is rendered in a semi-circular shape, FIG. 1, to easily fit around the circumference of a piling in the building and construction industry. Pilings vary in sizes e.g., eight-inch diameter, 10-inch diameter, and 12-inch diameter, with the 10-inch diameter being the most common form.

A semi-circular shape is necessary for the device according to this invention to create seat cut marks since industry standards disallow pilings to be cut more than halfway through their diameter. Therefore, a complete circular shape for the Circular Carpenter's Surface Level tool according to this invention is not needed.

The bull's eye (surface) spirit level feature, FIG. 1, is used as opposed to the standard bubble level vial so that the true 360-degree surface level of the present device is established prior to the seat cut mark being made upon the piling.

The pin feature, FIG. 1, of said device is used to anchor the tool at the proper height on each piling so the seat cut mark is consistent over all pilings used in the building or construction project.

FIG. 1, indicates two small holes which are drilled completely through the depth of the tool at each extreme end of the semi-circular frame. These two features allow the tool to be hung from a hook or wire for storage or carrying purposes or may also allow for future modifications of the device.

The design should be rendered in a light-weight material, such as cast aluminum, to aid industry workers in its ease of use, durability, and affordability. Ideally, device would be offered as a set, which would include all the standard sizes: eight-inch diameter, 10-inch diameter, and 12-inch diameter.

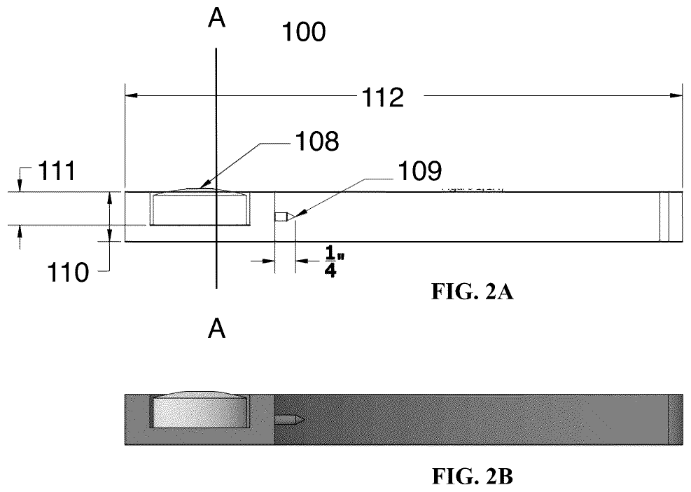

Referring now to the FIGS. 1-4, further details regarding the Semi-Circular Carpenter's Surface Level are provided. In FIG. 1, a top plan view, there is shown the level 100 according to one embodiment of this invention in which, for purely exemplary purposes, provides certain dimensions which may be desirable in making this device for use in the field. In this embodiment, an elliptical, hemi-circular structure (hemi-and semi-circular being used interchangeably in this disclosure), is provided with, in this embodiment, a diameter, 101, of 101 8 inches, with the opening where the second hemisphere or a circle would be, 102, having, for purposes of this embodiment, precisely ten inches, with a tapered outer diameter which tapers to a total 103 8 inches, rounded at each terminus, 104 and 105, connecting to the inner diameter 101. A through hole is also provided at each terminus 104 and 105, for purposes of storage. At its broadest dimension, 106, for purposes of this exemplary embodiment, has a diameter of 11^{3/8} inches. At its widest dimension 107, that is, where the inside and outside diameters are separated from each by the greatest distance, there is embedded a bull's eye bubble level 108, which, for purposes of this exemplary embodiment, has an outer diameter of about 1^{1/2} inches. A pin 109 projects from this central point, aligned with the central point of the bull's eye bubble level 108 projects from the inner circumference of the semi-circular level 100, for this example, ¼ inches toward the notional center of the circle created by the nesting inner 101 and outer 106 circumferences. Section A-A is shown in detail in FIG. 2.

In FIG. 2A, additional exemplary dimensions for embodiment 100 are provided, including a thickness 110, depending on materials from which the level is manufactured, and the height 111 of ½ inch of the recessed bull's eye bubble level 108. A total front to back dimension 112 of 8^{3/8} inches. In FIG. 2B, a solid form projection of 100 shown in FIG. 2A is provided.

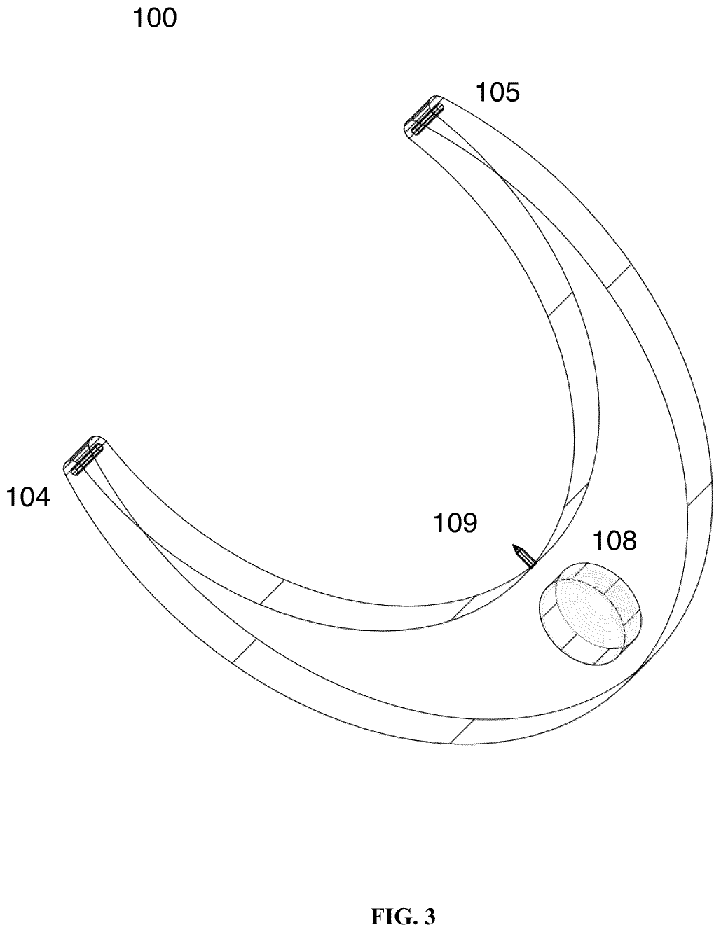

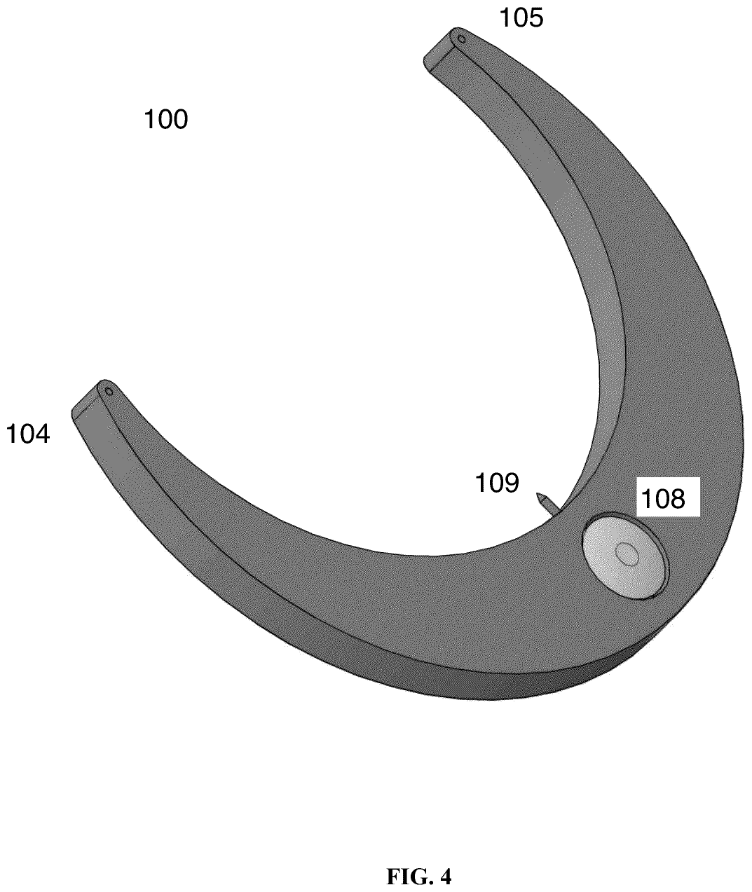

FIGS. 3 and 4 provide, respectively, see-through and solid isometric representations of the device 100.

Those skilled in the art, provided with this disclosure are enabled to make and use the semi-circular level described in detail herein. For an appreciation of the scope of the invention, reference should be had to the appended claims.

What is claimed is:

1. A level comprising a semi-circular frame used to ensure the seat mark on a substantially circular object is level.

2. The semi-circular level according to claim 1, comprising:
a bull's eye spirit level set within a semi-circular frame, to facilitate creation of level seat cuts on pilings.

3. The semi-circular level according to claim 2, used in conjunction with a laser, or transit, level, to make level seat cuts on several pilings.

4. The semi-circular level according to claim 3 fabricated from lightweight, cast aluminum metal.

5. The semi-circular level according to claim 4 in any of three standard sizes: eight-, 10-, and 12-inch diameters at the opening where the second hemisphere of a complete circle would be.

6. The semi-circular level according to claim 1 having an eight-inch diameter, a 10-inch diameter, or a 12-inch diameter at the opening where the second hemisphere of a complete circle would be.

7. The semi-circular level according to claim 2 further comprising a pin to anchor the tool at the proper height on each piling so each seat cut mark is consistent over all pilings used in a building or construction project.

8. The semi-circular level according to claim 1 further comprising two small holes completely through the semi-circular level, at each extreme end of said semi-circular frame.

9. The semi-circular level according to claim 1 rendered in cast aluminum.

10. A method to cut pilings, where a girder is to be placed, at precisely level points on each of said pilings, such that a floor of a building is level when resting on said pilings and girders, said method comprising:
making seat cut notches in said pilings in one motion by positioning a semi-circular level upon said pilings where a girder is to be placed, without the need to repeatedly reposition said level, as required when a straight edged level is used to make seat cut notches in pilings.

11. The method according to claim 10 further comprising using said semi-circular level in conjunction with a laser level or transit tool to indicate from one piling to the next where each seat cut is to be made by positioning said semi-circular at a height indicated by said laser.

12. The method according to claim 10 which provides a true 360-degree surface level prior to a seat cut mark being made upon the piling.

13. A kit comprising three semi-circular levels, a first having an eight-inch diameter, a second having a 10-inch diameter, and a third having a 12-inch diameter.
